(19) United States
(12) Patent Application Publication
(10) Pub. No.: US 2013/0062082 A1
(43) Pub. Date: Mar. 14, 2013

(54) SYSTEMS AND APPARATUSES FOR RESHAPING GROUND SURFACES

(71) Applicant: Jack D. Layton, Salem, OR (US)

(72) Inventor: Jack D. Layton, Salem, OR (US)

(21) Appl. No.: 13/229,533

(22) Filed: Sep. 9, 2011

(51) Int. Cl. A01B 63/02

(52) U.S. Cl. 172/445.1; 172/439

(57) ABSTRACT

Embodiments provide a grading and/or scarifier apparatus configured to be coupled to a motor vehicle, such as a tractor. The apparatus may include a rear mounted frame supporting a blade assembly and/or a scarifier. The scarifier may include a first frame, a second frame slideably disposed through the first frame, and scarifier shanks retained by the second frame. The blade assembly may be pivotable around a substantially vertical axis extending from the blade assembly and/or around a substantially horizontal axis extending through the center of the motor vehicle. The blade assembly may include adjustable end plates at each end, which are maintained at a constant angle to the horizontal axis as the blade is pivoted around the vertical axis. The apparatus may further include trailing wheels that are pivotally attached to the frame and selectively laterally displaceable with respect to the horizontal axis.

### TECHNICAL FIELD

Embodiments herein relate to the field of graders, scarifiers, and other apparatuses for construction of roads and other ground surfaces.

### BACKGROUND

A variety of machines are used in the construction industry for site aggregate placement on large jobs such as highways, county roads, streets, and large parking areas. Examples of such machines and devices include motor graders, skip loaders with rear boxes, skid steer machines, crawler dozers, excavators, and others. However, these machines have limited utility for smaller jobs that require fast and accurate finishing of rock aggregate. As a consequence, manual labor is still required for such tasks in confined areas, modern parking facilities, and in other areas with obstructions such as planters, curbs, and sidewalks. In addition, the operation of these machines and devices typically requires substantial training and experience.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 is a perspective view of a rear mounted grader apparatus with a scarifier in accordance with various embodiments;

FIG. 2 is a side view of the rear mounted grader apparatus of FIG. 1;

FIG. 3a is a plan view of the rear mounted grader apparatus of FIGS. 1-2;

FIGS. 3b and 3c are plan views of the inner frame assembly and outer frame assembly, respectively, of the rear mounted grader apparatus of FIGS. 1-3a;

FIG. 4 depicts two perspective views of the scarifier depicted in FIGS. 1-2, in lowered and raised positions, respectively;

FIG. 5 is a side view of a side frame assembly of the rear mounted grader apparatus of FIGS. 1-4

FIGS. 6a and 6b are block diagrams illustrating horizontal (FIG. 6a) and vertical (FIG. 6b) rotational axes of the blade assembly of the rear mounted grader apparatus of FIGS. 1-5;

FIG. 7 is a plan view of the rear mounted grader apparatus of FIGS. 1-6, illustrating the rotation of a blade assembly around a vertical axis;

FIG. 8 is a rear view of selected components of the rear mounted grader apparatus of FIGS. 1-7;

FIG. 9a is a plan view illustrating the lateral extension of a trailing wheel on the rear mounted grader apparatus of FIGS. 1-8;

FIGS. 9b and 9c are perspective views illustrating the lateral extension of a trailing wheel on the wheel mounted grader apparatus of FIGS. 1-8;

FIGS. 9d and 9e are plan views illustrating the angle adjustment of an end plate on the rear mounted grader apparatus of FIGS. 1-8;

FIG. 10 depicts two perspective views of an assembly configured to raise and lower each end of a blade assembly of the rear mounted grader apparatus of FIGS. 1-9, showing the blade assembly in raised and lowered positions; and

FIG. 11 is a perspective view of a portion of a blade assembly and gauge of the rear mounted grader apparatus of FIGS. 1-10.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

Various components, and sides/surfaces thereof, may be described as “proximal” or “distal” to one or more points or planes of reference. Unless otherwise specified, the terms “proximal” and “distal” are used to describe the location and/or orientation of components or sides/surfaces thereof) in relation to a motor vehicle coupled to the apparatus, a hitch coupled to the motor vehicle, or an apparatus component that is configured to be coupled thereto. Likewise, the “front” or “front end” of the apparatus refers to those portions of the apparatus that is configured to be coupled to the motor vehicle and/or hitch, and the “rear,” “posterior,” or “back end” refers to those portions of the apparatus that are most distal to the “front” or “front end.” Thus, unless otherwise specified, a “proximal” surface/side of a component is closer to the motor vehicle, hitch, or frame member than a “distal” surface/side of that component. Other points or planes of reference, such as a vertical axis or a horizontal axis, may instead be used to describe components, or sides/surfaces thereof, as “proximal” and “distal” to those other points or planes of reference where specifically indicated.

The terms “vertical,” “horizontal,” and derivative terms thereof, may be used in reference to one or more components and/or points or planes of reference. Where such terms are used to describe components of an apparatus, they are used in reference to the positions/orientations of the components while the apparatus is in a position for use and exerting downward force on a ground surface (as opposed to a retracted position in which the apparatus is suspended above the ground by a motor vehicle for transport). These terms are relative, and may be used to describe components and/or planes of reference that are generally or substantially “vertical” or “horizontal”. Unless otherwise specified, a “vertical” component or axis need not be perfectly perpendicular to a reference plane or surface (e.g., the ground, a pavement surface, etc.), and a “horizontal” component or axis need not be perfectly parallel to the reference plane or surface.

As used herein, the term “tractor” refers to a motor driven vehicle configured to pull or draw an implement such as farming or construction machinery. A tractor may be equipped with one or more functional components coupled to the front and/or rear of the tractor, such as a tractor-loader equipped with a front mounted loader.

As used herein, the term “actuator” refers to a component that is configured to selectively apply force against another component. In the examples described below, the term “actuator” may be used in reference to a hydraulic cylinder and piston assembly. Such actuators may be coupled to a pressurized oil system of a tractor, and may be used to raise, lower, push, pull, rotate/pivot, or otherwise adjust the position of another component. However, in other examples an “actuator” may be or include any other suitable source of motive force known in the art (e.g., a pneumatic cylinder, a motor, etc.) Such devices are known in the art and will not be further described herein.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

In various embodiments, methods, apparatuses, and systems for surface grading are provided. In exemplary embodiments, a computing device may be endowed with one or more components of the disclosed apparatuses and/or systems and may be employed to perform one or more methods as disclosed herein.

Embodiments herein provide apparatuses and systems for grading, scarifying, or otherwise altering surfaces during the construction and/or maintenance of roads, parking facilities, and other areas. As described further below, a grading apparatus may be coupled to one end of a motor vehicle, such as a tractor. In some embodiments, a grading apparatus may include a rear mounted frame supporting a blade assembly and/or a scarifier. The blade assembly may be pivotable around a substantially vertical axis extending from the blade assembly. The blade assembly may also be pivotable around a substantially horizontal axis extending through the center of the motorized vehicle/frame. The grading apparatus may further include one or more trailing wheels that are selectively positionable along an arcuate path, and/or are laterally displaceable with respect to the frame. Components subjected to wear, such as the blade and replaceable teeth, may be coupled to the grading apparatus with one or more removable fasteners, such as bolts.

The frame of the apparatus may include an inner frame assembly and an outer frame assembly. In some examples, the inner frame assembly is configured to be coupled to an existing three point hitch already installed on the motor vehicle. In other examples, the inner frame assembly includes a three point hitch. In either case, the three point hitch may include a center arm (i.e., a top link) and two lower arms. The forward ends of the lower arms may be coupled to, and pivotally supported by, one end of the motorized vehicle. The lower arms may be movable, and a component of the motor vehicle (e.g., a hydraulic cylinder or hydraulic system of a tractor) may provide motive force to raise, lower, or tilt the lower arms around their forward pivotal axes. In some examples, the three point hitch may also include a pair of upper arms. In some examples a pair of upper arms may be mounted on a transverse rock shaft. The upper arms may extend above the lower arms and may be pivotally connected to the lower arms by draft arm links. In some examples, one or both of the draft links may be replaced with a leveling cylinder to allow adjustment or leveling of the lower arms.

The proximal portion of the inner frame may be supported by the lower two ball joints of the lower arms. The center arm may also be movable. In some examples, the center arm may be, or may be coupled to, an actuator. The center actuator may be selectively operable to ‘float’ or to be locked into a position. While the actuator is floating, the apparatus may be at least partially supported by the ground and in a position for use in normal grading operations. Raising the lower arms and locking the actuator may allow the grader apparatus to be raised, such as for transport of the apparatus on the job site or to load the motorized vehicle and apparatus for transport to another location.

The outer frame assembly may include one or more horizontal supports and adjustable trailing wheels. The horizontal supports may be configured to be mounted to the rear wheels of a motor vehicle, such as a tractor, or to a portion of the motor vehicle frame forward of the rear wheels of the motor vehicle. The horizontal supports may include two or more joined components that are configured to slide laterally with respect to one another in a telescoping arrangement, allowing extension and retraction of the horizontal supports. The trailing wheels may be pivotally coupled to the outer frame assembly and selectively positionable along an arcuate path around the site of attachment. The trailing wheels, and the portions of the horizontal supports to which they are coupled, may be selectively movable toward and away from a horizontal center line of the inner frame via actuation of movable lateral supports coupled to the blade assembly and to the outer frame. This configuration may allow the trailing wheels to be selectively positioned by an operator to trail behind the blade during normal operation or to be extended outwardly from the blade. The trailing wheels may be extended outwardly, for example, to match an existing or established grade (e.g. concrete or AC slab, concrete curbs or gutters, material previously placed by the blade system, and/or another ground reference) using an outside reference.

The blade assembly may be pivotally mounted to the inner frame assembly and pivotable around a vertical axis, allowing the blade to be angled to the right and left, respective to the center line of the tractor. In addition, the blade assembly may be coupled to the inner frame via a pivot bearing and may be pivotable around a horizontal axis, allowing the lateral ends of the blade to be symmetrically or asymmetrically raised and lowered. For example, the blade may be selectively positionable with the left end of the blade higher than the right end of the blade, or vice versa. This configuration may allow the blade depth at each end of the blade assembly to be adjusted independently of the blade depth at the opposite end. The blade assembly angle and the depth of the lateral ends of the blade may be selectively adjusted via actuators coupled to, and controlled from, the vehicle operator's position. The position of the inner frame or components attached thereto may also be adjusted by the operator of the motor vehicle to adjust the angle of the blade.

The blade assembly may include adjustable end plates pivotally coupled to the blade assembly at each lateral end of the blade assembly, forming ‘wings’. The adjustable end plates may also be connected to the inner frame by a sliding mechanism coupled to an actuator assembly. The actuator assembly may be selectively operated by an operator to position the end plates at a desired angle to the center line of the tractor/inner frame. As the blade is rotated (i.e., around a vertical axis and/or a horizontal axis), the disclosed arrangement may allow the sliding mechanism to remain horizontally parallel to the blade assembly and to maintain the adjustable end plates at the selected angle, relative to the center line of the tractor. Thus, the end plates may be maintained at the selected angle regardless of the angle of the blade.

The blade assembly may be pivoted around the horizontal axis, as described above, by way of a vertical adjustment assembly coupled to the outer frame assembly and to the blade assembly. The vertical adjustment assembly may also be coupled to the movable lateral supports, such that the heights of each lateral end of the blade assembly may be selectively adjusted whether the movable lateral supports are extended or retracted. A control block may be coupled to the inner frame assembly, the actuators, and a control panel disposed near the operator's position. The control block may provide an electrical, mechanical, hydraulic, and/or other type of connection between the control panel and the actuators, allowing an operator to remotely control some or all of the actuators of the grading apparatus from the control panel. Thus, the control block may provide electrical signals and/or motive force for remote independent adjustment of the vertical and horizontal angles of the blade assembly, the angles of the end plates, the lateral and rotary position of the trailing wheels, and the positions of various other components (e.g., extension and retraction of the horizontal supports and scarifier assembly components). For example, the control block may be a hydraulic block with valves, one or more manifolds, and electronic circuitry that operably connects the apparatus control panel to some or all of the actuators of the grading apparatus.

Gauges with reference numbers for blade depth reference may be coupled to the outer frame assembly proximal to the trailing wheels. The gauges may include one or more gauge pointers coupled to the blade assembly. The gauge pointer(s) may provide a visual indication of the position of the blade assembly, such as blade depth, for cutting, leveling, or filling surface material. The gauges may allow the blade position to be preset by the operator while moving backwards (e.g., as the operator is backing the motorized vehicle and grading apparatus into position for grading a surface). In some examples, the ends of the blade assembly can be vertically adjusted by the operator with a single control, such as a lever. The single control may be provided in a control panel, which may have one or more other controls for operation of other components of the apparatus. Thus, configurations described herein provide overlap of operational functions for improved efficiency.

In some examples, the apparatus may include a scarifier assembly. The inner frame may include a horizontal cross frame portion coupled to the lower arms of the three point hitch. The cross frame portion may include two sockets that extend from the top surface to the bottom surface of the cross frame portion, as well as an upright support member extending upwardly from the upper surface between the two sockets. Two slide tubes may be disposed vertically through the sockets. A bottom frame member positioned below the cross frame portion may connect the slide tubes. The bottom frame member may be raised and lowered by moving the slide tubes vertically through the sockets. Scarifier shanks may be anchored in the bottom frame member. The shanks may be inserted as individual units or as one or more units (e.g., a unified comb structure). In some examples, the scarifier shanks may be provided with replaceable teeth. The cross frame portion and/or upright support member may be coupled to the bottom frame by an actuator, such as a hydraulic cylinder. A torque bar may be disposed through stationary brackets on the cross frame and/or upright member, and one or more linkages may connect the slide tubes to the torque bar. As the actuator urges vertical displacement of the bottom frame, the torque bar may ensure that equal force is applied to the shanks at each end of the bottom frame member. The actuator may be coupled to the control panel. Thus, the depth of penetration into the surface material may be selectively adjusted by an operator from within the motor vehicle.

Examples of such apparatuses are provided in the Figures and corresponding description below. As shown in the Figures, a rear mounted grader apparatus may include a blade assembly and/or a scarifier assembly, an inner frame assembly, and outer frame assembly. These examples are provided merely by way of illustration, and are not intended to be limiting. In particular, persons with reasonable skill in the art will readily understand that other components may be substituted for those described, and that portions of the illustrated apparatus may be adapted for other uses. For example, the scarifier assembly may be converted to a brush assembly by replacing the scarifier shanks with brush heads. Such modifications and adaptations are contemplated within the present disclosure.

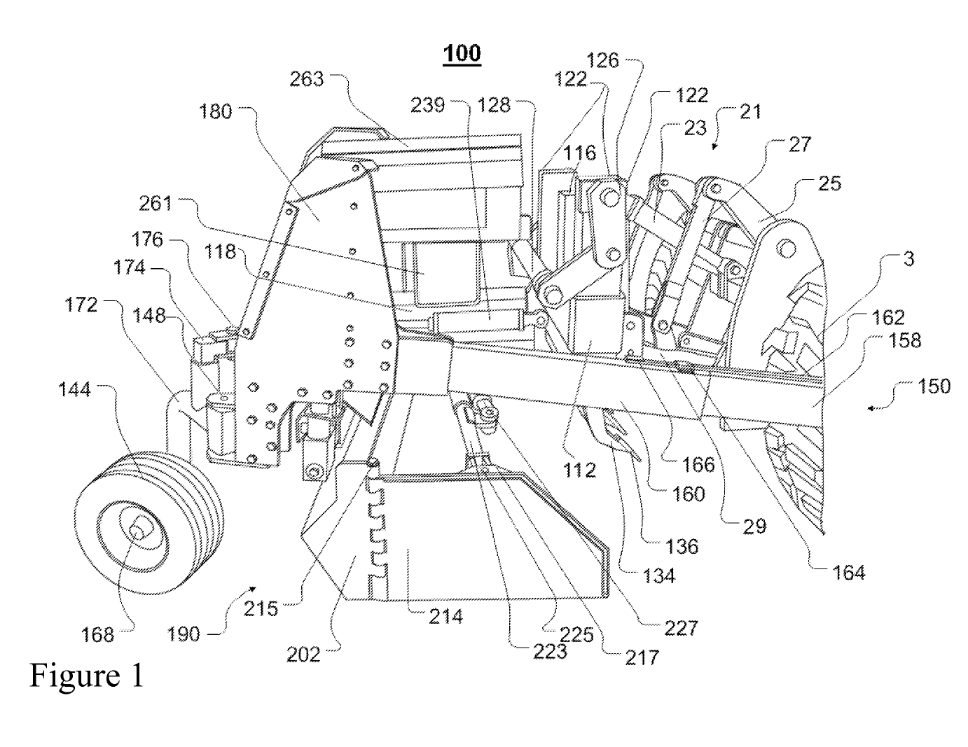

Referring now to FIGS. 1-4, a grader apparatus 100 may be coupled to a motor vehicle via a three point hitch 21. In the illustrated embodiment, the motor vehicle is a tractor. The tractor may be, but is not limited to, any 50 to 130 hp (horsepower) tractor. Alternatively, the motor vehicle may be a tractor with greater than 130 hp. For example, the motor vehicle may be a 50-130 hp tractor with an existing Category 2 three point hitch system and weight on the drive tires of up to 14,000 Lbs.

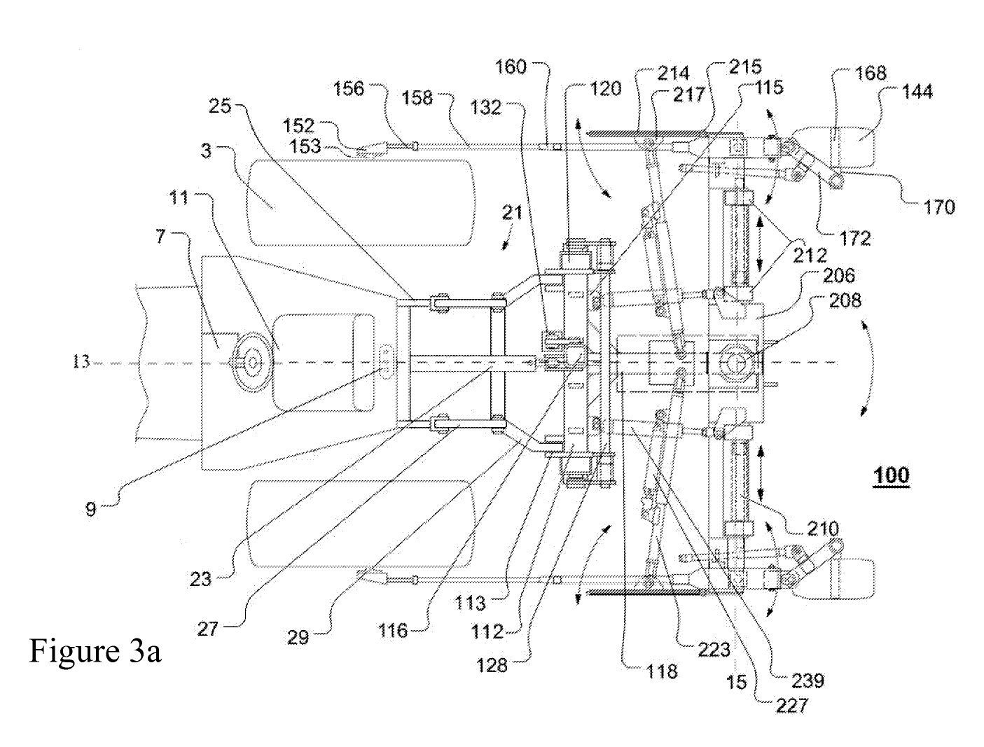

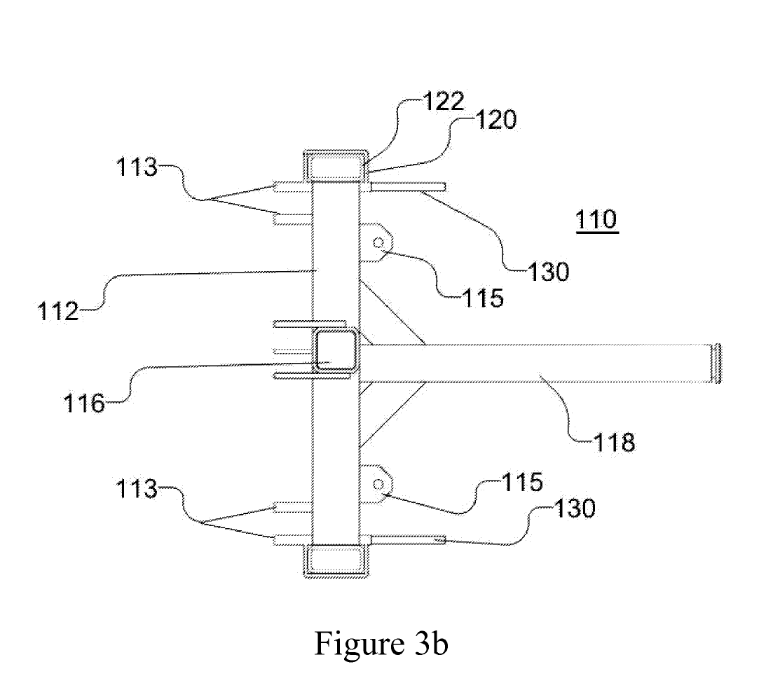

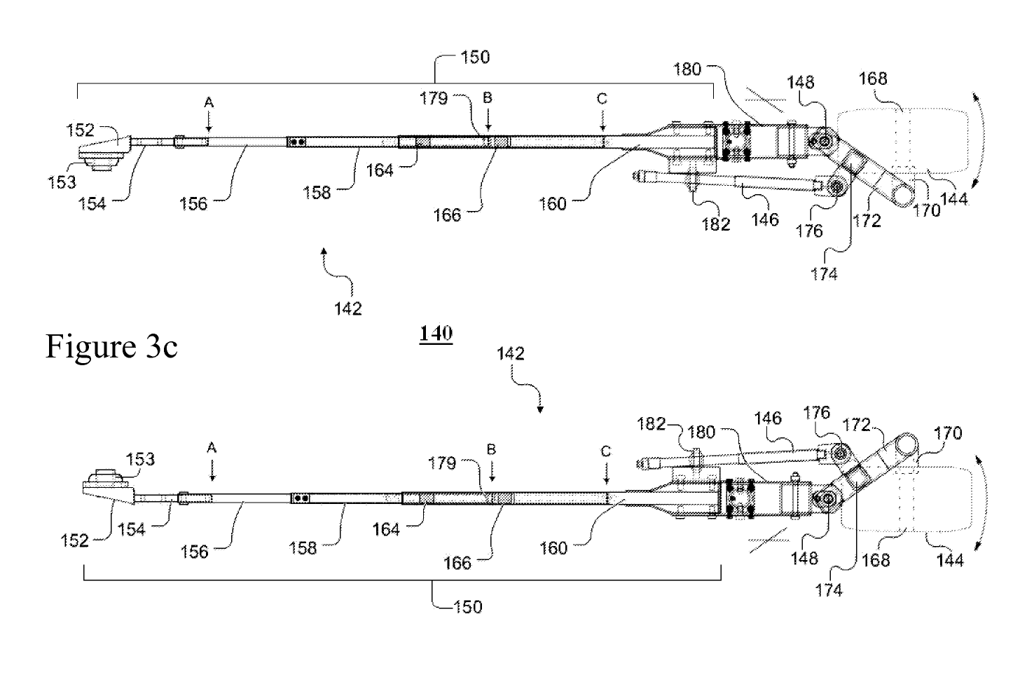

As shown in FIG. 3a, the tractor may include rear wheels 3, a tractor control console 7, an apparatus control panel 9, and operator housing 11. Operator housing 11 may include a seat, an open or closed cab, and/or any other area of a tractor typically occupied by an operator during use of the tractor. Tractor 1 may have a horizontal center axis 13, illustrated in FIG. 3a for ease of reference. Apparatus control panel 9 may be positioned on or within the tractor, and may be physically, electronically, electrically, hydraulically/pneumatically, or otherwise operatively coupled to one or more of the actuators of grader apparatus 100. In some examples, apparatus control panel 9 is mounted to an exterior portion of the tractor and located behind the seat or cab. In other examples, apparatus control panel 9 may be positioned within the cab or elsewhere.

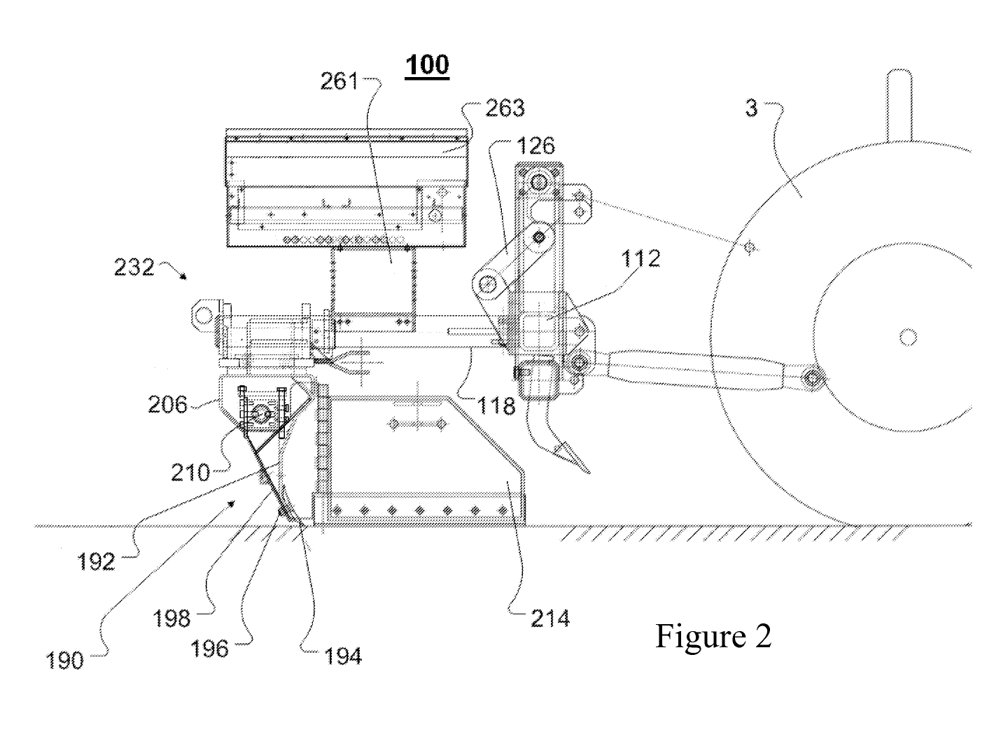

Grader apparatus 100 may include an inner frame assembly 110 (FIG. 3b) and an outer frame assembly 140 (FIG. 3c). As best shown in FIG. 3a, inner frame assembly 110 may be reversibly coupled to the tractor by a three point hitch 21 coupled to the frame of the tractor. Three point hitch 21 includes a center arm 23, two upper arms 25, two link arms 27, and two lower arms 29 (see FIGS. 1 and 2). The lower arms 29 are movably coupled to the tractor, and can be raised and lowered by way of a hydraulic cylinder or other known motive force mechanism. Center arm 23 is movably coupled to the tractor above and/or between lower arms 29.

The inner frame assembly 110 (FIG. 3b) includes a cross frame member 112 and upright support 116. Inner frame assembly 110 may also include a medial frame member 118 that extends from a distal side of cross frame member 112 substantially along a horizontal center axis 13. Cross frame member 112 is pivotally coupled at its two lateral ends, via brackets 113 (FIGS. 3a and 3b), to the distal ends of lower arms 29. Upright support 116 extends vertically from the upper surface of the cross frame member 112 and is pivotally coupled to the distal end of center arm 23 (see also FIG. 1). In this example, center arm 23 is a hydraulic cylinder that can be selectively locked at a desired position (e.g., fully retracted) or unlocked and permitted to freely extend and retract (i.e., ‘floating’). The grader apparatus 100 can be raised by raising the lower arms 29 and retracting center arm 23. Center arm 23 may then be selectively locked in that position, such as for transport of the grader apparatus on a job site or to load the motorized vehicle and apparatus for transport to another location. While the actuator is floating, the apparatus may be at least partially supported by the ground and in position for use in normal grading operations.

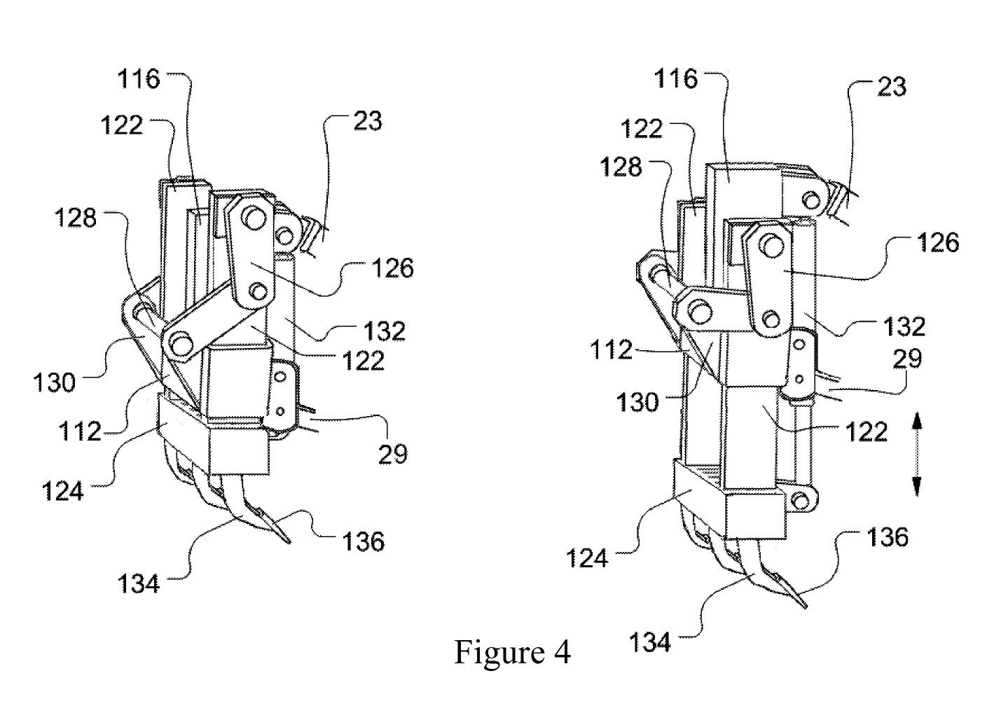

In some embodiments, inner frame 110 may form a portion of a scarifier assembly. FIG. 4 provides two perspective views of a scarifier assembly in accordance with various embodiments described herein. As best shown in FIG. 3b, cross frame member 112 may include one or more sockets 120 that extend through the cross frame member from the upper surface to the lower surface. Referring again to FIG. 4, slide tubes 122 are movably disposed through the sockets 120. A bottom frame member 124 extends laterally below cross frame member 112 and joins the slide tubes 122. Scarifier shanks 134 may be disposed through, or coupled to the lower surface of, bottom frame member 124. Optionally, replaceable teeth 136 may be coupled to scarifier shanks 134.

Each slide tube 122 may be coupled to one end of an articulated arm 126 (FIG. 4). The other end of each articulated arm 126 may be coupled to a torque bar 128, which may be secured within brackets 130 disposed on the distal side of cross frame member 112. An actuator 132, such as a hydraulic cylinder, may be coupled to cross frame member 112 and/or upright support 116 and to bottom frame member 124. Actuator 132 may provide motive force to raise and lower the bottom frame member 124. As the actuator 132 raises and lowers the bottom frame member 124, the torque bar maintains equal force on the scarifier shanks at each end of the bottom frame member 124. The depth of penetration into the surface material is controlled by an operator via control panel 9 (FIG. 1).

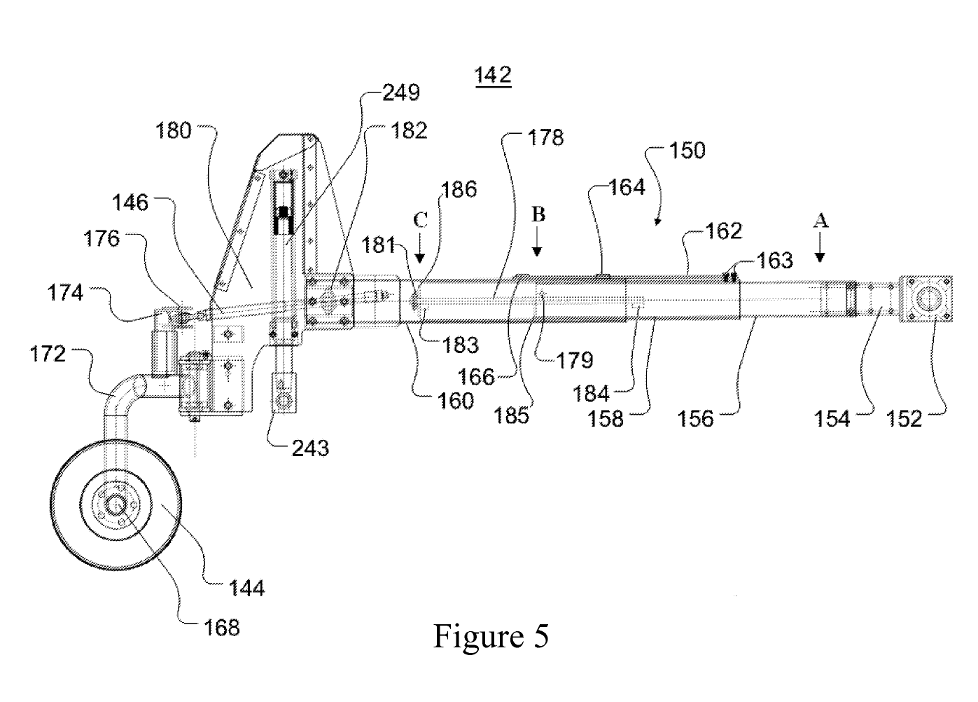

Referring now to FIG. 3c, the outer frame assembly 140 may include two side frame assemblies 142. Each side frame assembly 142 may further include a side plate 180 coupled to a horizontal support 150 and to a trailing wheel 144. Horizontal support 150 may include a mount 152, a coupler 154, a first slideable arm 156, a second slideable arm 158, and/or a side plate arm 160 (see FIGS. 3c and 5). Mount 152 may be configured to be coupled to a wheel of a motorized vehicle (e.g., to a rear wheel 3 of the tractor) or to the frame of the motorized vehicle by bolts or other fasteners. Coupler 154 may be a plate, bar, or other structure used to join mount 152 to the remaining components of horizontal support 150. Some embodiments may lack one or more of these components. For example, coupler 154 may be omitted and mount 152 may be coupled to first slideable arm 156.

Mount 152 may include a pivot bearing 153 (FIG. 3c). The pivot bearing 153 may have two outer portions that are independently rotatable around a central axis. One outer portion may be coupled to the rear wheel of the motorized vehicle (e.g., placed around the axle, or secured with bolts or other fasteners) and the other outer portion may be bolted or otherwise fastened to the proximal end of coupler 154. The distal end of coupler 154 may be received within first slideable arm 156. Coupler 154 may be bolted or otherwise fastened to the proximal end of first slideable arm 156. Coupler 154 may have multiple bolt holes or attachment sites spaced at intervals along its length (FIG. 5). Multiple attachment sites may be provided to accommodate variations in the distance between the distal end of the rear wheel of the tractor and the attachment site for the apparatus (e.g., the lower arms 29 of the three point hitch, FIG. 1) among different tractor and three point hitch configurations. For example, the lower arms of a three point hitch may extend 6 to 8 inches behind the distal end of the rear wheel of one tractor, while the lower arms of the three point hitch may extend 15 to 17 inches behind the distal end of the rear wheel of another tractor. Therefore, the distance between mount 152 and the proximal end of first slideable arm 156 may be adjusted by removing the bolts or other fastener(s) from the bolt holes or attachment sites, pushing or pulling coupler 154 within first slideable arm 156 to place the proximal end of first slideable arm 156 at the desired distance from mount 152, and replacing the bolts or other fastener(s) in the corresponding both holes or attachment sites.

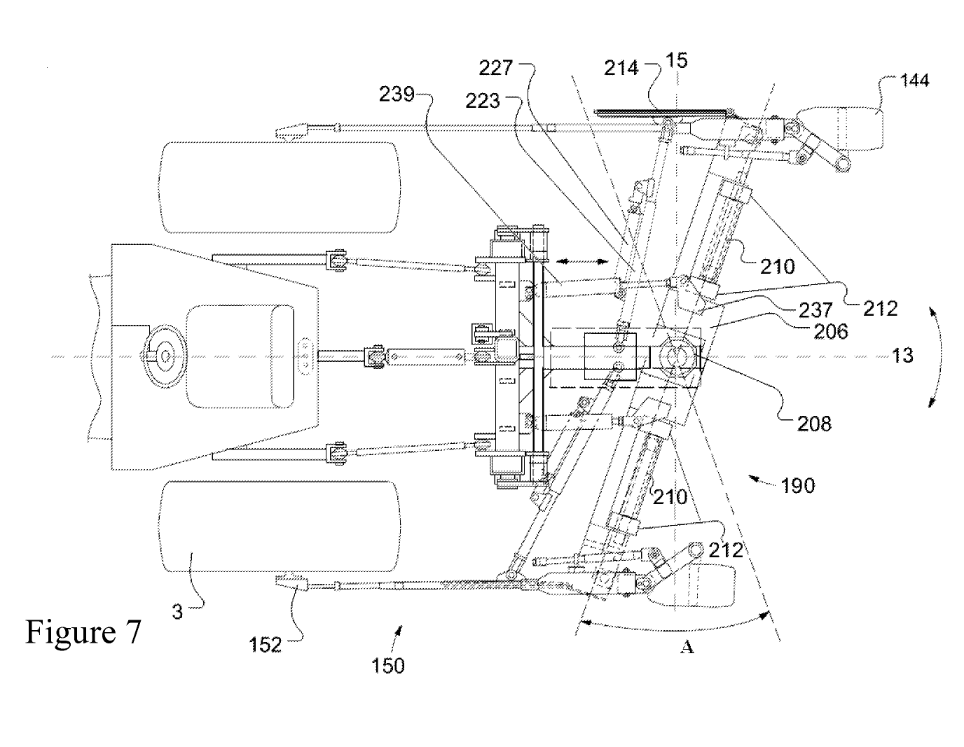

The distal end of first slideable arm 156 is received within the proximal end of second slideable arm 158. The distal end of second slideable arm 158 is received within a proximal end of side plate arm 160. The telescoping configuration of these components is best shown in FIGS. 3c and 5, in which the distal ends of coupler 154, first slideable arm 156, and second slideable arm 158 indicated by Arrows A, B, and C, respectively. This telescoping configuration allows extension and retraction of horizontal support 150 relative to rear wheel 3 of the tractor. As best shown in FIG. 7, the sliding/telescoping horizontal supports 150 accommodate rotation of the blade assembly 190 around a vertical axis, which allows the angle of the blade to be adjusted as desired. The telescoping configuration also allows the blade assembly to be extended and retracted, and allows the grading apparatus to be drawn into a more compact form for transportation

One or more components may be provided to stabilize the telescoping motion of the arms and/or to limit the retraction and extension of horizontal supports 150. In the illustrated example (FIG. 5), an extension control member 178 may be disposed between first slideable arm 156 and second slideable arm 158. An end guide 185 may be coupled to the distal end of first slideable arm 156, and another end guide 186 may be coupled to the distal end of second slideable arm 158. Extension control member 178 may pass through a hole or notch (not shown) in end guides 185 and 186. Upper and lower guide members may also be provided to prevent vertical displacement of extension control member 178. As shown in FIG. 5, an upper guide member 179 (e.g., a pin or bolt) may be disposed through first slideable arm 156, and one or more lower guide members (e.g., lower support member 183) may be coupled to second slideable arm 158 and/or first slideable arm 156. The upper and lower guide members may limit the vertical movement of extension control member 178. Alternatively, a continuous or semi-continuous channel/track assembly (not shown) may be used to guide and stabilize the telescoping motion of the arms.

A stop member 184 may be coupled to the proximal end of extension control member 178. Another stop member 181, such as a bolt, may be coupled to the distal end of extension control member 178. The stop members 184 and 181 may limit the extension and retraction of first slideable arm 156 into second slideable arm 158. First slideable arm 156 may be extended from second slideable arm 158 until stop member 184 is brought into contact with end guide 185, blocking further extension of first slideable arm 156 from second slideable arm 158. Likewise, first slideable arm 156 may be retracted into second slideable arm 158 until end guide 185, upper guide member 179, or other component coupled to first slideable arm 156 is brought into contact with end guide 186 and/or stop member 183. This contact may block further retraction of first slideable arm 156 into second slideable arm 158.

Additional components may be provided to limit the extent of expansion and retraction of second slideable arm 158 into side plate arm 160. In the example shown in FIG. 5, a guide member 162 is attached at its proximal end to the proximal end of second slideable member 158 by bolts 163. A bracket 164 is coupled to the upper surface of side plate arm 160, and the guide member 162 is slideably disposed through bracket 164. A stop member 166 is attached to the distal end of guide member 162 (see also FIG. 1). Stop member 166 and bolts 163 may exceed the dimensions of the gap created by bracket 164, providing a stop at each end of guide member 162. In operation, as second slideable arm 158 is retracted into side plate arm 160, guide member 162 slides through bracket 164. Second slideable arm 158 may be retracted into side plate arm 160 until the bolts 163 reach bracket 164, which prevents further retraction of second slideable arm 158 into side plate arm 160. Likewise, as second slideable arm 158 is extended from within side plate arm 160, guide member 162 slides through bracket 164 until stop member 166 reaches bracket 164, which prevents further extension of second slideable arm 158 from side plate arm 160. The proximity of stop member 166 to bracket 164 may provide a visual indicator of the degree of extension/retraction.

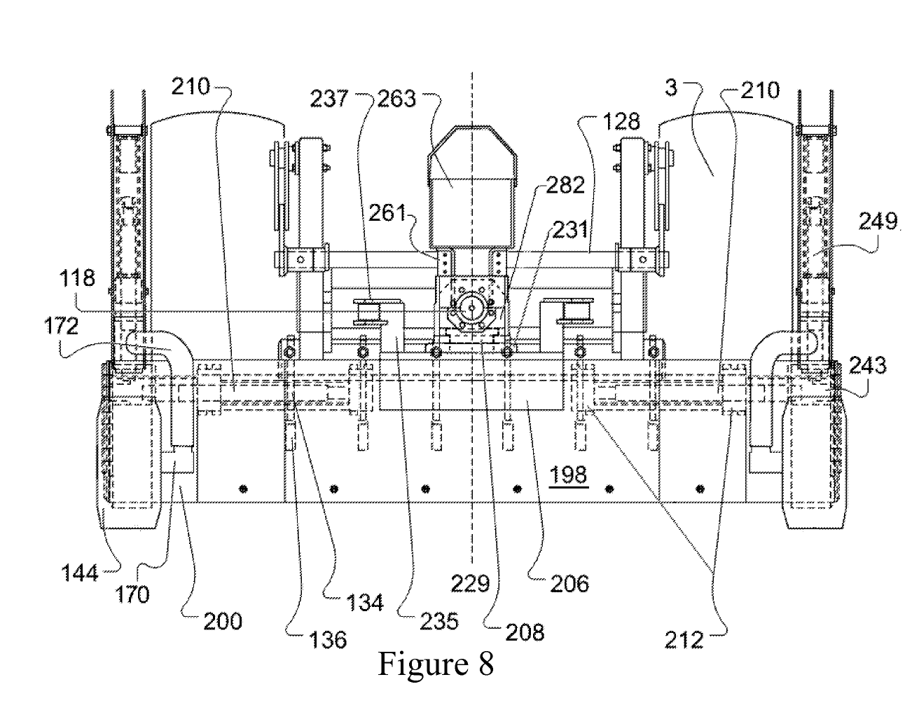

Referring again to FIG. 3c, each side frame assembly 142 also includes a trailing wheel 144. Trailing wheel 144 is rotatable around axle 168, and a portion of axle 168 is rotatably received within a lower end of axle support 170. An upper end of axle support 170 is received within trailing wheel support 172 (see also FIG. 8). Trailing wheel support 172 may be pivotally coupled to side plate 180 via a vertically disposed pivot member 148 (see also FIG. 1), allowing trailing wheel support 172 and trailing wheel 144 to move along an arcuate path as shown by the corresponding arrows in FIG. 3c. Thus, outer frame assembly 140 is supported by the rear wheel 3 of the tractor (or alternative attachment site on the frame of the tractor) and by the trailing wheels 144.

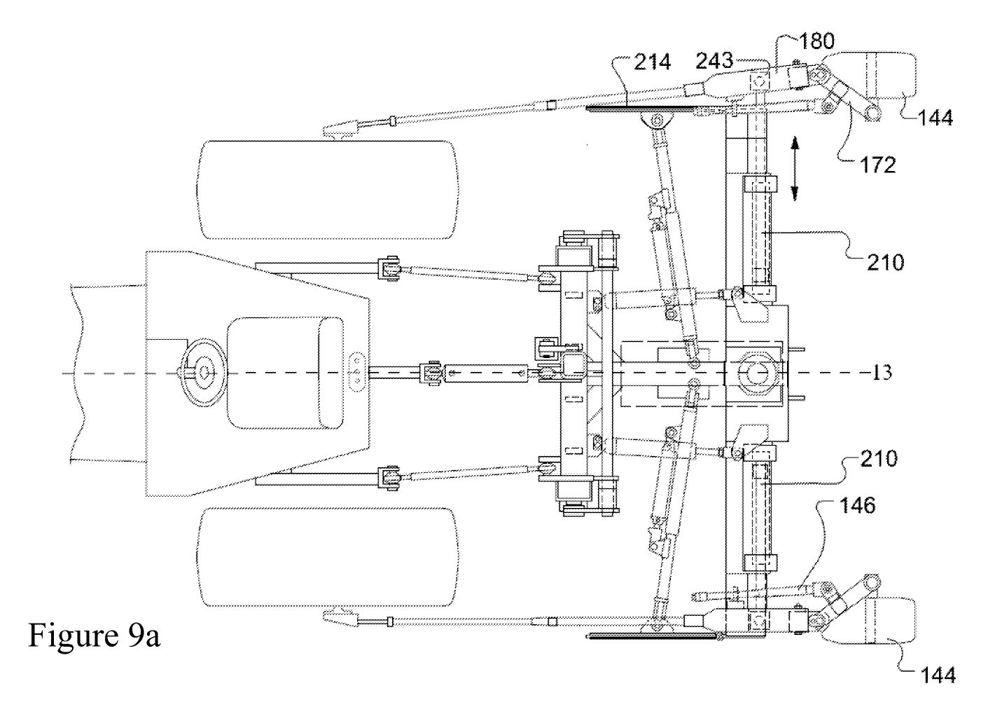

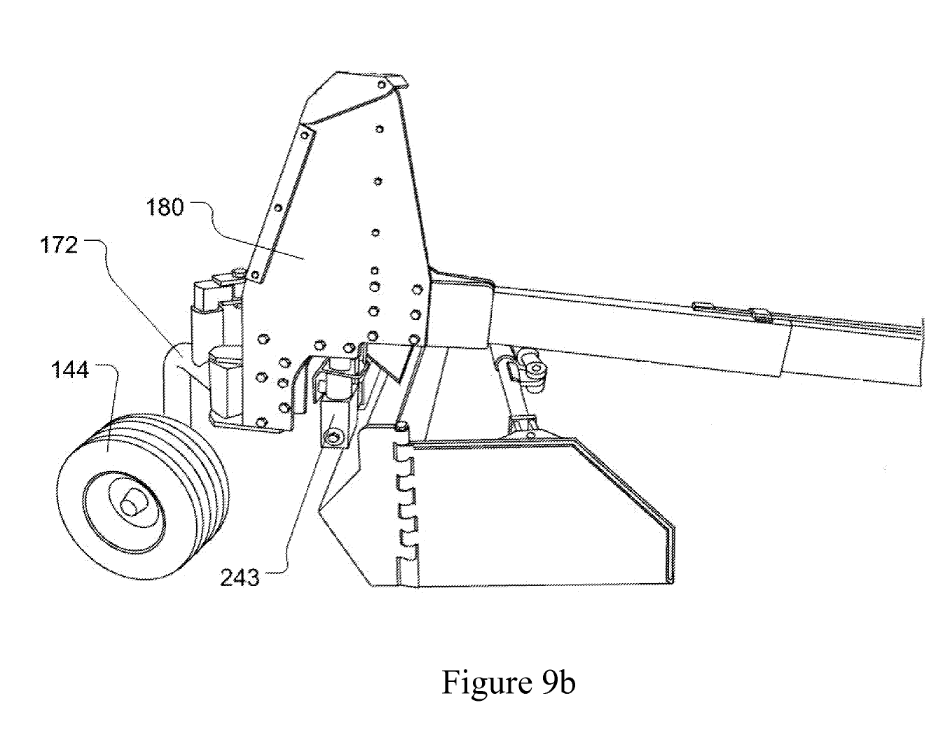

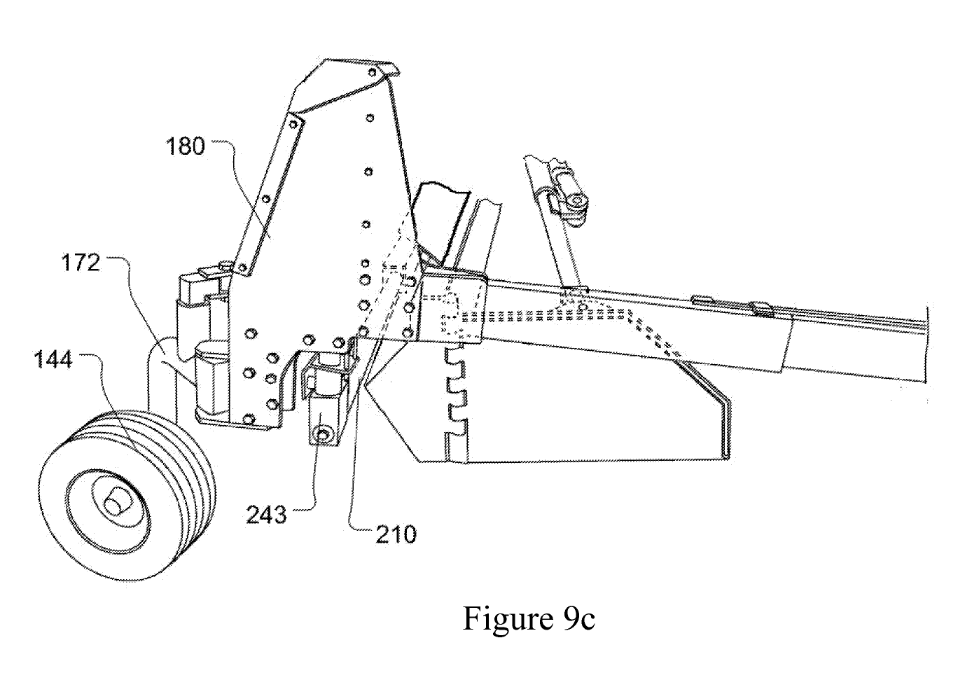

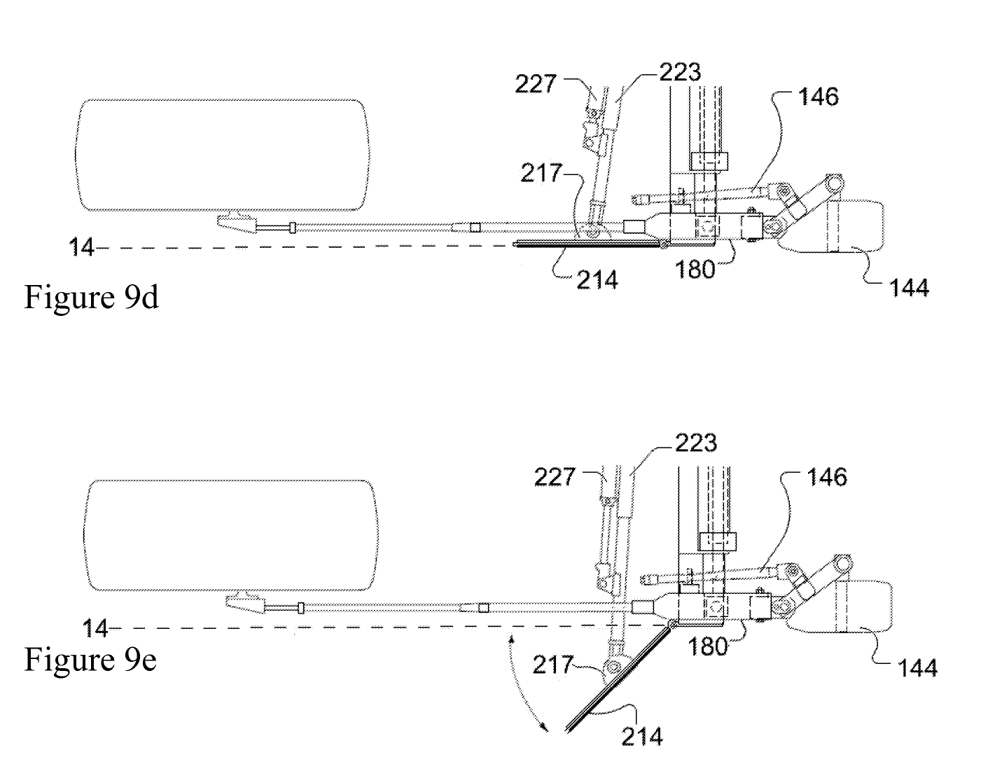

Motive force for controlling travel of trailing wheel support 172 along the arcuate path may be provided by actuator 146. Actuator 146 may be pivotally coupled to trailing wheel support 172, such as by way of a coupler 174 that extends from trailing wheel support 172 (see also FIG. 1). Coupler 174 and a first end of actuator 146 may be pivotally coupled by pivot member 176. Actuator 146 may also be fixedly or movably coupled at its opposite end, or along its length, to side plate 180. In the illustrated example, actuator 146 is coupled to side plate 180 via a bracket 182. In some examples, bracket 182 may be configured to allow swiveling or limited rotation of actuator 146. Actuator 146 may be used to selectively apply force to trailing wheel support 172, thereby adjusting the position of trailing wheel support 172 along the arcuate path. In addition, as shown in FIGS. 9a-c and described further below, the trailing wheel supports 172 are laterally extendable and retractable by movable lateral supports connected to the outer frame assembly 140 and to the blade assembly. Thus, the arcuate path traveled by trailing wheels 144 can be shifted laterally away from the center line 13 of the tractor/inner frame.

A blade assembly 190 may be coupled to the inner frame assembly 112 and to the outer frame assembly 140 (FIG. 2). Blade assembly 190 may include a support panel 192. Support panel 192 may be generally arcuate in shape and may extend horizontally below side plate arms 160. One or more cutting members 194 may be fastened to the lower end of the proximal side of support panel 192 by bolts 196. Optionally, one or more components of the blade assembly and/or scarifier assembly may be constructed from high strength steel. Examples of high strength steel include, but are not limited to, carbon steels and alloy steels. For example, the cutting member 194 may be constructed from alloy steel that includes molybdenum and/or chromium, such as steel with the SAE designation of 4572. Such blades may have a useful service life of 2000-10000 hours (e.g., 5000 hours).

Optionally, one or more exterior panels may be coupled to the opposite side of support panel 192. In the illustrated embodiment, the bolts 196 that secure the cutting member 194 to the proximal side of support panel 192 also secure an exterior panel 198 and two exterior side panels 200 to the distal side of support panel 192. Exterior end panels 202 are provided at the lateral ends of support panel 192. As shown, exterior end panels 202 may be integral to support panel 192. Alternatively, they may be constructed as separate units and joined by welding, bolts, or other fasteners.

An end plate 214 may be pivotally coupled to each end of the blade assembly 190 at the proximal ends of exterior end panels 202 (see FIG. 1). In some embodiments, end plate 214 and exterior end panel 202 have corresponding hinge portions that are coupled with a vertical pivot member 215. The opposite ends of end plates 214 may be tapered and/or curved. Optionally, one or more additional cutting members may be removably coupled to the lower portion of the interior surface of end plate 214.

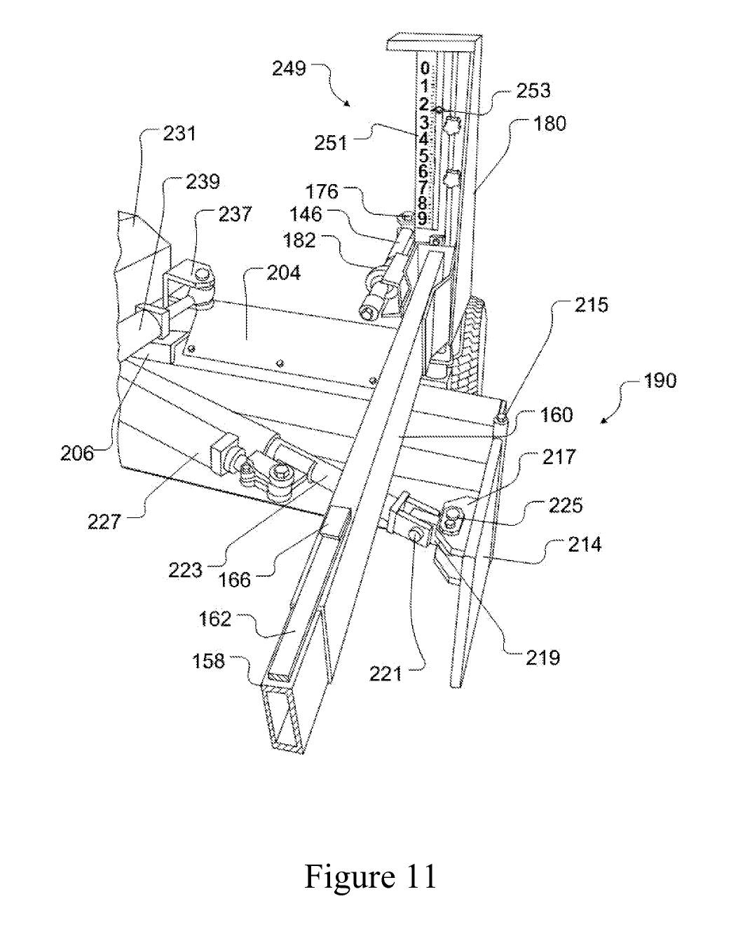

As shown best in FIG. 11, the interior surface of each end plate 214 (i.e., the surface facing the horizontal center axis 13) may be provided with an end plate bracket 217. A coupler 219 may be pivotally coupled to end plate bracket 217 by a pivot member 225, allowing the coupler 219 to pivot around a substantially vertical axis. Coupler 219 is pivotally coupled by pivot member 221 to one end of a slideable arm 223, which includes a pair of telescoping rods. The opposite end of slideable arm 223 is pivotally coupled to medial frame member 118.

Mounted on each slideable arm 223 is an actuator 227 (FIGS. 3 and 11). The actuators 227 provide motive force to adjust the angle of the end plates 214 relative to horizontal center axis 13. FIGS. 9d and 9e illustrate the adjustment of the angle of an end plate 214. For ease of reference, FIGS. 9d and 9e show a horizontal axis 14 that extends parallel to the horizontal center axis 13. FIG. 9d shows an end plate 214 positioned at an angle of 0°, or parallel to horizontal center axis 13/horizontal axis 14. FIG. 9e shows the same end plate 214 positioned at an angle of 45° relative to the same axes. End plates 214 may be positionable at various angles between 0° (i.e., parallel to center axis 13) and 45°, such as 5°, 10°, 15°, 20°, 25°, 30°, 35°, 40°, or other angles within that range. The lengths of the blade assembly and end plates may vary among embodiments. For example, a support panel 192 with integral end panels 202 may be eight feet in length and the two end plates 214 may be three feet in length, allowing for a grading width of eleven feet when the support panel is positioned at an angle of 90° and the end plates 214 are positioned at an angle of 45° relative to the horizontal center axis 13. As described further below, slideable arms 223 maintain the selected angle of the end plates 214 relative to horizontal center axis 13 when the support panel is angled.

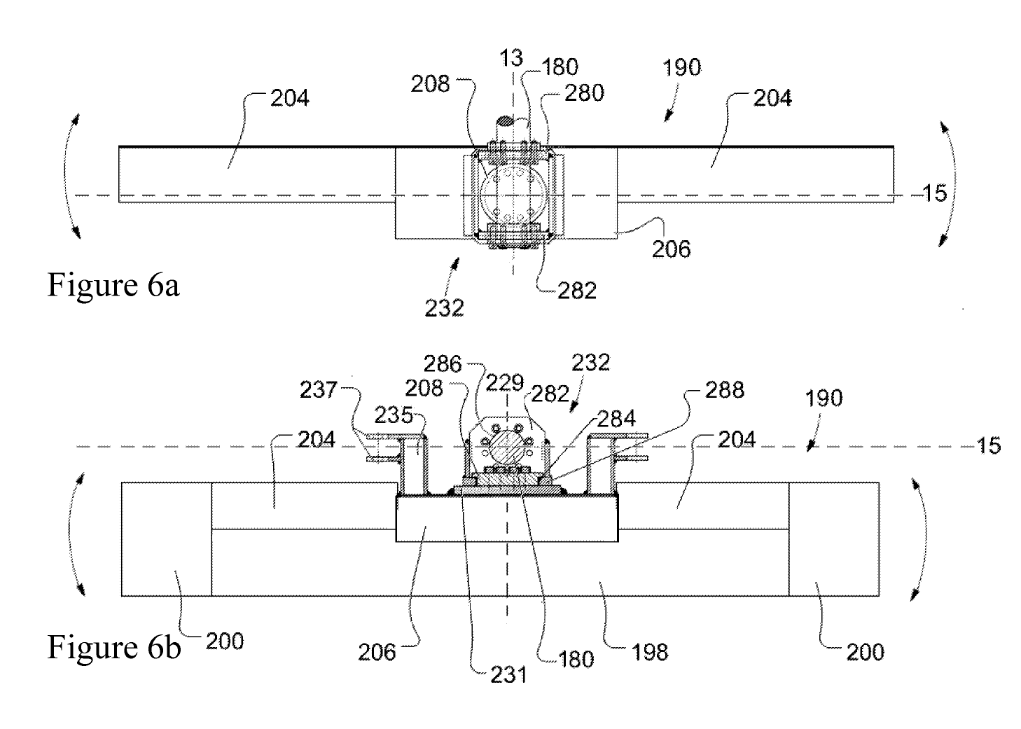

Blade assembly 190 may be pivotable around both a vertical axis, allowing the blade to be angled with respect to horizontal center axis 13, and/or pivotable around a horizontal axis, allowing the height of each end of the blade to be adjusted independently (FIGS. 6a and 7). A support mount 206 may be coupled to the upper surface of support panel 192. Support mount 206 may be positioned centrally, in alignment with a substantially vertical axis 229 extending upwardly through the center of the blade assembly 190. Optionally, one or more exterior top panels 204 may also be coupled to the upper surface of support panel 192 at one or both sides of support mount 206.

Support mount 206 may be coupled to a pivot assembly 232 (FIG. 2). FIGS. 6a and 6b show block diagrams of blade assembly 190 and pivot assembly 232 as a plan view (FIG. 6a) and a rear elevational view (FIG. 6b; see also FIG. 8). FIG. 6a illustrates the vertical rotational axis of blade assembly 190, while FIG. 6b illustrates the horizontal rotational axis of blade assembly 190 (indicated by arrows).

As illustrated in FIGS. 6a and 6b, pivot assembly 232 may include a top mount 231, a proximal yoke member 280, a distal yoke member 282, a retaining member 288, and a pivot bearing 208. Referring to FIG. 6b, top mount 231 may be fixedly coupled along its bottom surface to support mount 206. Retaining member 288 may be positioned on the upper surface of top mount 231, and may have an interior aperture with a bearing surface 284 (e.g., a lubricated bearing surface). The bottom of pivot bearing 208 may be fixedly coupled to support mount 231. Pivot bearing 208 may extend vertically through the interior aperture of retaining member 288, with the upper portion of pivot bearing 208 retained on the upper surface of retaining member 288. For example, pivot bearing 208 may include an upper lip or edge that rests on the upper surface of retaining member 288. As pivot bearing 208 rotates around vertical axis 229, top mount 231, support mount 206, and blade assembly 190 are also rotated.

Retaining member 288 may be fixedly coupled to distal yoke member 282 and proximal yoke member 280. Distal yoke member 282 and proximal yoke member 280 may extend vertically upward, and each may include an aperture with an inner bearing surface (e.g., bearing surface 286, shown in FIG. 6b). The distal end of medial frame member 118 may extend through the apertures of distal yoke member 282 and proximal yoke member 280. Thus, distal yoke member 282 and proximal yoke member 280 are rotatable around medial frame member 118 and center horizontal axis 13. This configuration allows the lateral ends of blade assembly 190 to be independently raised and lowered, as discussed further below. Distal yoke member 282 and proximal yoke member 280 may be rotatable around medial frame member 118 within a range of 10° (i.e., 5° clockwise to 5° anticlockwise), 20° (i.e., 10° clockwise to 10° anticlockwise), or more than 20°.

Support mount 206 may include support mount brackets 237 (FIGS. 6b, 8 and 11). In some examples, two support mount brackets 237 may be secured to corresponding bracket support members 235 that extend upwardly from the support mount 206 at equal distances from the vertical axis 229. As best shown in FIGS. 3a, 7, and 11, each support mount bracket 237 may be pivotally coupled to one end of a corresponding actuator 239. The opposite end of each actuator 239 may be pivotally coupled to brackets 115 of cross frame member 112. For example, an actuator 239 may be coupled to the left support mount bracket 237 and to a similar bracket disposed on the left side of upright support 116. The actuators 239 are operable to apply force against the corresponding bracket support members.

As best shown in FIG. 7, the combination of pivot bearing 208 and the extension and retraction of horizontal supports 150 (FIG. 7) allow an operator to selectively adjust the angle of blade assembly 190. The blade assembly 190 can be angled by operating the actuators 239 to apply force against the two bracket support members 235. For example, extending one of the actuators 239 while retracting the other actuator 239 causes the blade assembly 190 to pivot around vertical axis 229 (FIG. 6b), altering the angle of the blade assembly with respect to horizontal center axis 13. FIGS. 3a and 7 show blade assembly 190 in a non-rotated position (FIG. 3a) and a rotated position (FIG. 7). A longitudinal axis 15 is indicated in these Figures for ease of reference. Longitudinal axis 15 is perpendicular to, and intersects, horizontal center axis 13 and vertical axis 229 (see also FIGS. 6a and 6b). As blade assembly 190 is rotated around vertical axis 229, the lateral ends of the blade assembly form opposite angles of equal magnitude with respect to longitudinal axis 15. In the non-rotated position shown in FIG. 3a, blade assembly 190 is rotated 0° around vertical axis 229. The blade assembly 190 extends parallel to longitudinal axis 15, and each end of the blade assembly extends at an angle of 90° to horizontal center line 13. In the rotated position of FIG. 7, blade assembly 190 is shown rotated 20° clockwise around vertical axis 229, with one lateral end of the blade assembly at an angle of 70° to horizontal center axis 13.

The range of rotation (Arrow A, FIG. 7) of the blade assembly 190 around vertical axis 229 may vary among embodiments. For example, blade assembly 190 may have a range of rotation of 40° around vertical axis 229 (e.g., from 20° clockwise to 20° anticlockwise), allowing the blade assembly to be selectively positioned at any corresponding angle within that range (e.g., with one lateral end of the blade assembly at an angle of 70° to 110° to horizontal center axis 13). As another example, blade assembly 190 have a range of rotation of 90° around vertical axis 229 (e.g., from 45° clockwise to 45° anticlockwise), and the blade assembly may be selectively positioned at any corresponding angle within that range (e.g., with one lateral end of the blade assembly at an angle of 45° to 135° to horizontal center axis 13). Alternatively, blade assembly 190 may have any range of rotation between 40° and 90°.

As force is applied to one bracket support member 235 by the corresponding actuator 239, the corresponding horizontal support 150 extends or retracts accordingly, allowing blade assembly 190 to rotate around vertical axis 229. This allows blade assembly 190 to be extended, retracted, or pivoted/tilted around a vertical axis by the operator as desired. Again, actuators 227 may be used to selectively position end plates 214 at a desired angle with respect to horizontal center axis 13, and slideable arms 223 may maintain the selected angle of the end plates 214 relative to horizontal center axis 13 regardless of the angle of blade assembly 190.

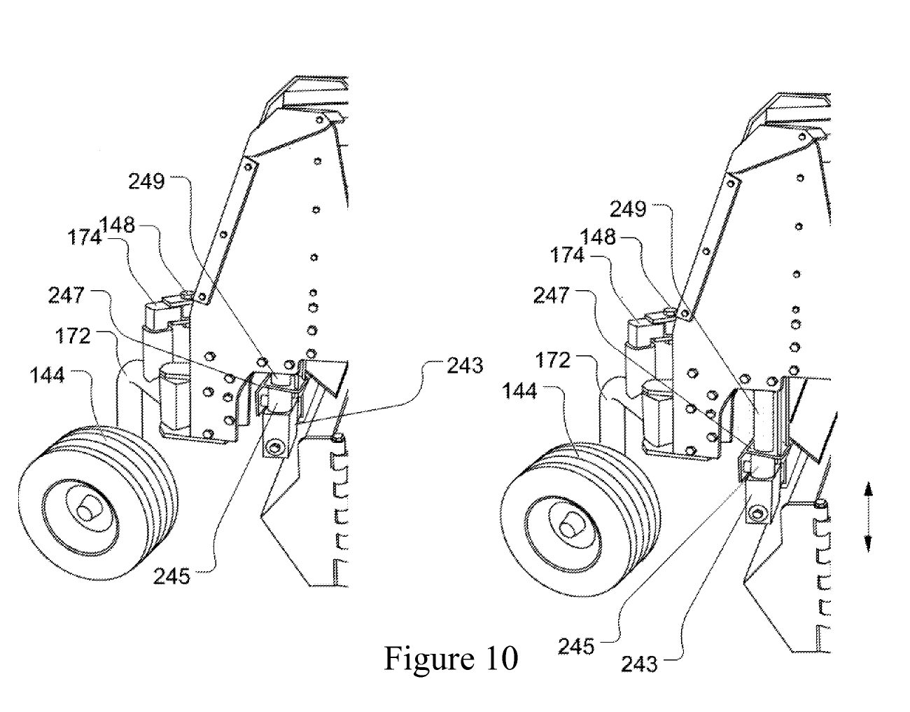

As shown in FIG. 10, the lateral ends of blade assembly 190 can be independently vertically adjusted. Extendable lateral supports 210 (see FIGS. 3a and 8) are disposed horizontally along both ends of blade assembly 190 and are coupled to blade assembly 190 by one or more lateral support brackets 212. Lateral supports 210 may be positioned between exterior panel 198 and exterior top panel 204 (see e.g., FIG. 2). In some examples, lateral supports 210 are mechanical actuators, such as hydraulic cylinders, that can be actuated to extend and retract. The outermost end of each lateral support 210 is received within, or is coupled to, a base 243. Base 243 (FIG. 10) may be positioned between the blade assembly 190 and the trailing wheel 144. Extending upwardly from base 243 is a support 245 with a horizontal plate 247 coupled to its upper surface. A vertical adjustment member 249 extends upwardly from base 243. In some embodiments, vertical adjustment member 249 is a mechanical actuator, such as a hydraulic cylinder, that can be actuated to extend and retract. One end of vertical adjustment member 249 is coupled to an inner/interior surface of side plate 180, and the other end is coupled to base 243 and/or support 245 (see FIGS. 5 and 8). Each lateral end of blade assembly 190 can thus be raised and lowered, independently of the opposite lateral end, by actuating the corresponding vertical adjustment member 249.

Gauges 249 with reference numbers 251 for blade depth reference may be coupled to each side plate 180, proximal to the trailing wheels 144 (FIG. 11). A gauge pointer 253 may be coupled to the blade assembly 190. As the blade assembly 190 is raised or lowered on one side, the corresponding gauge pointer 253 is also raised or lowered to indicate the position of the blade.

Referring again to FIG. 9a, the trailing wheels 144 can be moved toward and away from a horizontal center line 13 of the tractor/inner frame 110 by actuation of the movable lateral supports 210. As lateral supports 210 are extended outwardly, the corresponding bases 243 and side plates 180 are also pushed outward from horizontal center line 13. Because the trailing wheel supports 172 are coupled to the side plates 180, the trailing wheels 144 are also moved away from horizontal center line 13. Similarly, retraction of lateral supports 210 results in the movement of trailing wheel supports 172 toward horizontal center line 13. This configuration allows the trailing wheels to be positioned by the operator of the motor vehicle to trail behind the blade during normal operation or to be extended outwardly from the blade. The trailing wheels may be extended outwardly, for example, to match an existing or established grade (e.g. concrete or AC slab, concrete curbs or gutters, material previously placed by the blade system, and/or another ground reference) using an outside reference.

Turning again to the inner frame 110, a vertical support member 261 may be attached by bolts or other fasteners to medial frame member 118 (FIGS. 2 and 8). Vertical support member 261 may include two plates bolted to the sides of medial frame member 118 and extending upwardly. A control block 263 may be mounted to vertical support member 261. Control block 263 may include one or more hydraulic valves, manifolds, and/or electronic circuitry. Control block 263 may electrically, mechanically, and/or hydraulically connect the control panel 9 to one or more of the above-described actuators, allowing an operator to remotely control and adjust various components of the grading apparatus from the control panel 9. Control block 263 may provide electrical signals and/or motive force for remote independent adjustment of the vertical and horizontal angles of the blade assembly, the angles of the end plates, the lateral and rotary position of the trailing wheels, the extension and retraction of the horizontal supports, and one or more optional components, such as an actuator of a scarifier assembly.

A plurality of couplers (not shown) may be coupled to control block 263 and to any of the actuatable components and control panels/systems described above. For example, at least some of the couplers may be conduits for pressurized hydraulic fluid, (e.g., hydraulic pipes, tubes, or hoses). One or more of the couplers may extend through an enclosed passage defined by the bottom of control block 263, the top of medial frame member 118, and the interior sides of vertical support member 261. Control block 263 may be electronically coupled to apparatus control panel 9 and/or to a hydraulic system of the tractor. Thus, control block 263 may be used by an operator (via apparatus control panel 9) to control and adjust the movable components of grader apparatus 100 as described above.

Optionally, as best shown in FIG. 8, one or more lights, fasteners, or other components may be coupled to support mount 206, support mount brackets 237, or bracket support members 235. For example, one or more fasteners (not shown) may be coupled to support mount brackets 237. The fasteners may include clips or clamps configured to retain one or more hydraulic hoses that convey pressurized hydraulic fluid between the control block 263 and one or more of the above-described actuators (e.g., actuators 146, lateral supports 210, vertical adjustment members 249, actuators 239, actuators 227). The fasteners may be used to support the hydraulic hoses to reduce the risk of damage or interruption of their function from vibrations and/or moving components of the apparatus.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

1.-13. (canceled)

14. An apparatus with an adjustable trailing wheel assembly, comprising:
an inner frame member configured to be mounted to a motorized vehicle, the inner frame member defining a horizontal center axis;
an outer frame assembly coupled to the inner frame member, the outer frame assembly having a proximal end, a distal end, a first horizontal support, and a second horizontal support, the first and the second horizontal supports extending between the proximal end and the distal end, wherein the proximal end of the outer frame assembly is configured to be mounted to the motorized vehicle;
a first wheel support member pivotally coupled to the outer frame assembly, wherein the first wheel support member is configured to pivot around a substantially vertical axis along a first arcuate path;
a first wheel rotatably coupled to the first wheel support member;
a first actuator coupled to the wheel support member and the outer frame assembly, the first actuator selectively actuable to position the wheel support member along the first arcuate path; and
a second actuator coupled to the first horizontal support, the second actuator selectively actuable to laterally displace the first wheel support member from a first position to a second position relative to the horizontal center axis, the first wheel support member configured to pivot around the substantially vertical axis along a second arcuate path in the second position.

15. The apparatus of claim 14, wherein the first wheel support member is coupled to a distal end of the first lateral support, and wherein the second actuator is configured to laterally displace the distal end of the first horizontal support from a first position to a second position.

16. The apparatus of claim 15, further comprising a third actuator coupled to the first horizontal support and the second actuator, the third actuator selectively actuable to vertically displace the second actuator.

17. The apparatus of claim 14, wherein the distal end of the first horizontal support comprises a rotatable member configured to be coupled to a rear axle or frame of the motorized vehicle.

18. The apparatus of claim 14, the first horizontal support comprising two or more horizontal support members arranged in a telescoping configuration with one of the two or more horizontal support members slideably received within another of the two or more horizontal support members.

19.-28. (canceled)
